(19) United States
(12) Patent Application Publication
(10) Pub. No.: US 2009/0158865 A1
(43) Pub. Date: Jun. 25, 2009

(54) MODULE AND APPARATUS FOR CONTROLLING AN ARTICLE, AND APPARATUS FOR REGULATING THIS MODULE

(75) Inventors: Jacques Dallongeville, Saint-Ouen L'Aumone (FR); Philippe Dubois, Mortefontaine (FR)

Correspondence Address: DENNISON, SCHULTZ & MACDONALD, 1727 KING STREET, SUITE 105, ALEXANDRIA, VA, 22314, US

(73) Assignee: SGCC, Gennevilliers (FR)

(21) Appl. No.: 12/298,273

(22) PCT Filed: Apr. 23, 2007
(86) PCT No.: PCT/FR07/51156

§ 371 Date: Nov. 24, 2008

(30) Foreign Application Priority Data
Apr. 24, 2006 (FR) 0603617

(51) Int. Cl. G01N 21/88; B65G 47/24

(52) U.S. Cl. 73/865.8; 356/239.4; 198/345.2

(57) ABSTRACT

A control module including means for controlling an article, means for regulating at least one parameter of the article control means, and means for driving the article towards the control means. More specifically, the module is movable and includes a releasable means of connection with a fixed frame. Preferably the drive means includes a carousel having at least one cell for housing the article, for example a glass bottle.

This present invention concerns a module for the inspection of an article, an installation for the inspection of an article and an installation for the adjustment of this module.

It applies more particularly to inspection of the quality of glass articles, in particular of glass bottles.

In a production chain, glass bottles have a tendency to present faults such as crazing for example.

In order to detect such faults on the bottles, the production chain includes a monitoring installation that includes an inspection module that is intended to monitor the quality of the glass bottles.

In the prior art, we are already aware of a module for the inspection of an article, of the type with means for the inspection of an article, means for adjustment of at least one parameter of the means for inspection of an article, and means for guiding the article to the inspection means.

In general, the guidance means include a carrousel with cells in which the bottles are positioned and then driven in rotation to the inspection means.

The inspection means generally include several sensors, such as optical sensors and pressure sensors. The parameters of the inspection means are the relative positions of the sensors in relation to the bottle to be inspected for example.

The bottles are usually mass produced in a series. Thus, in the conventional manner, the bottles belonging to a given series have shapes, colours and indeed gauges, that are identical.

In general, the carrousel includes cells that form receptacles for bottles of a given series. These cells have dimensions that match those of the bottles in the series.

As a consequence, at each change of series, it is necessary firstly to change the carrousel and secondly to adjust the parameters of the inspection means, in particular the relative positions of the sensors in relation to the bottle to be inspected.

Adjustment of the parameters of the inspection means is relatively lengthy and results in a relatively long stoppage of the production line.

The invention in particular has as its objective to reduce the down time of the production line in the event of changing the bottle series.

To this end, the subject of the invention is a module for the inspection of an article of the aforementioned type, characterised in that it is mobile and includes disconnectable means for connection to a fixed structure.

Thus, the inspection installation can include, for example, at least two inspection modules according to the invention. It is then possible to effect the adjustments for a first inspection module on an adjustment installation external to the production line while the second module is in operation in the inspection installation.

In the event of changing the series, one only has to exchange the inspection module attached to the fixed structure of the inspection installation with the inspection module already adjusted in the adjustment installation.

Thus, by means of the invention, the down time in the event of changing the series is reduced because it is no longer associated with the time for adjusting the parameters of the inspection means. Thus adjustment of the parameters can be performed with greater precision.

An inspection module according to the invention can also include one or more of the following characteristics:
the module includes first means for coupling the guidance means with a drive motor;
the guidance means include a carrousel with at least one receptacle cell for the article;
the inspection module includes means for removing an article from the carrousel to an inspection conveyor supported by the fixed structure;
the removal means include means for guidance of the article, that are fixed and rotating;
the inspection means include at least one sensor of the type in contact or not in contact with the article;
the sensor is chosen from among a optical sensor that is sensitive to a light beam that is transmitted or reflected by the article, an image sensor, a capacitive sensor and a pressure sensor;
the parameter of the inspection means is:
   a parameter for positioning these inspection means, to set the relative position of the sensor and the article for example, the position of a light source on the inspection means, a relative position of the sensor and a light source on the inspection means, or
   an electrical parameter for these inspection means, such as the gain of a electrical signal transmitted by the sensor to means for analysing the electrical signal;
the inspection means are divided between at least two inspection stations that are intended respectively to check at least two quality parameters, with the guidance means being intended to move the article from one inspection station to another inspection station;
the module is of general parallelpipedic form, and is intended to be inserted into a receptacle of complementary shape created in the fixed structure;
the disconnectable connecting means include at least one element for attaching the module to the structure chosen from among a rotating flange, a threaded pin, an element of the quick release type and a clamping bracket.
the module includes:
   first positioning means which determine a horizontal plane for vertical positioning of the module,
   second positioning means which determine a positioning axis of the module around a vertical axis,
   third positioning means which determine a positioning angle of the module around the axis,
where the second and third positioning means are intended to fit by vertical interlocking with complementary means on the structure;
the second positioning means are of the conical type or of the complementary pin and hole type, and the third positioning means are of the horizontal edge or oblong hole type;
the module includes means for attaching the module to a carrier of the lift type, intended for vertical interlocking and separation of the module and the structure;
the module includes electrical connection means that are complementary to electrical connection means on the structure;
the module is equipped with rollers that allow it to move;
the module is intended for the inspection of a glass article, and in particular a bottle.

The invention also has as its subject an installation for the inspection of an article of the type with an inspection module and a fixed structure, characterised in that the inspection module is in accordance with the invention, and is fixed to the structure by the disconnectable connecting means.

An installation for the inspection of an article according to the invention can include any of the following characteristics:
the structure includes an inspection conveyor and means for the insertion of an article coming from the inspection conveyor into the carrousel of the module;
the insertion means include an endless screw;
the inspection installation includes first means for transfer from a production conveyor to the inspection conveyor, and second means for transfer from the inspection conveyor to the production conveyor, with the first and second transfer means respectively having first and second means for guidance of the article, intended to form first and second passages between the two conveyors;
the fixed structure includes declutchable second means for coupling the drive motor with the insertion means.

The invention also has as its subject an installation for the adjustment of an inspection module that includes this inspection module and a fixed structure, characterised in that the inspection module is in accordance with the invention, and is fixed to the structure by the disconnectable connecting means, and in that it includes computer hardware and software means designed for adjusting the parameter of the inspection means.

The invention will be understood more clearly on reading the description that follows, and which is provided by way of a guide only, and with reference to the drawings, in which:

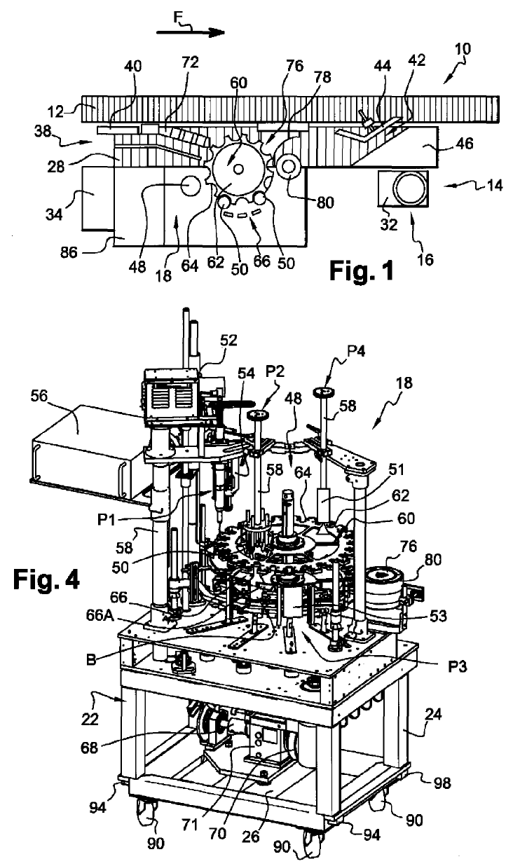

FIG. 1 is a view from above of a production chain for glass bottles, with a monitoring installation according to the invention;

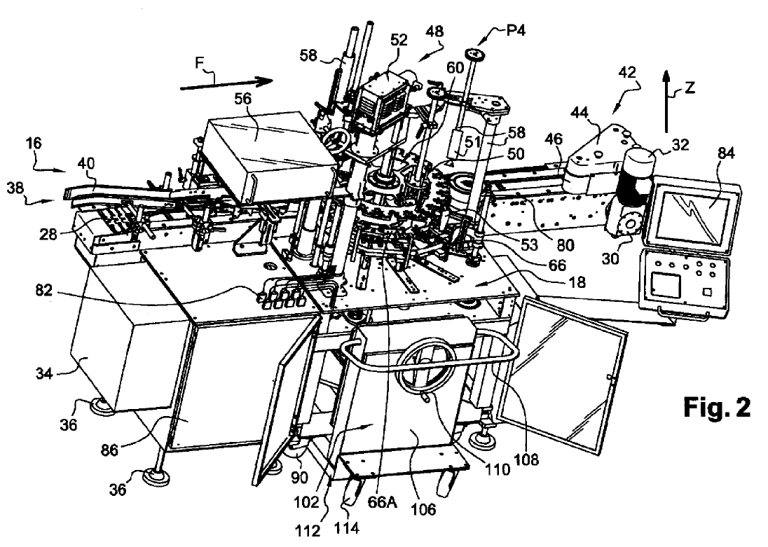

FIG. 2 is a view in perspective of the inspection installation represented in FIG. 1;

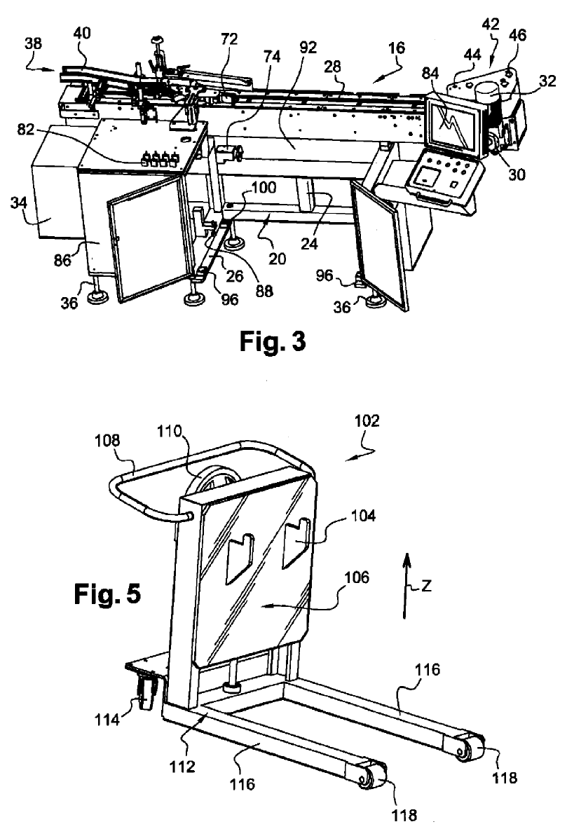

FIG. 3 is a view in perspective of a fixed structure of the inspection installation represented in FIG. 1;

FIG. 4 is a view in perspective of an inspection module according to the invention, which is intended to be fixed onto the fixed structure of FIG. 3;

FIG. 5 is a view in perspective of a carrier;

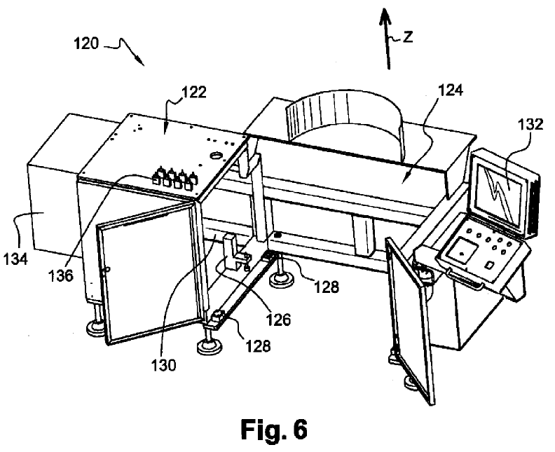

FIG. 6 is a view in perspective of a fixed structure of an adjustment installation according to the invention.

FIG. 1 represents a production line for articles, indicated by the general reference 10. In the example described, the article is in glass and in particular is a bottle (B).

The production line (10) includes a production conveyor (12) on which bottles move in the direction of the arrow (F).

The bottles are, for example, routed between a bottle-making station (not shown) on the production line (10), located upstream of the conveyor (12), to a bottle packing station (not shown) on the production line (10), located downstream of the production conveyor (12), in relation to the direction of movement (F) of the bottles.

In order to monitor the quality of these bottles, the production line (10) includes an installation (14) for inspection of the bottles, represented in detail in FIG. 2.

More precisely, the installation (14) includes a fixed structure (16), represented in FIG. 3, and an inspection module (18), attached to the structure (16) and represented in FIG. 4.

In the example described, the fixed structure (16) and the inspection module (18) respectively include rigid frames (20, 22). These rigid frames (20, 22) are composed of prefabricated elements, in the form, for example, of tubes (24), of plating (26), etc, with these prefabricated elements being made of steel and assembled by welding or bolting.

These frames (20, 22) form supports or receptacles for different elements of the inspection installation (14).

Thus, the fixed structure (16) includes an inspection conveyor (28). In a variant, the production (12) and inspection (28) conveyors can form a single conveyor.

In order to drive the conveyor (28), the fixed structure (16) also includes means (30) for coupling this conveyor (28) with a drive motor (32) of the conveyor (28).

The fixed structure (16) also includes a receptacle (34) intended to house an electrical power transformer (not shown), for the drive motor (32) of the conveyor (28) for example.

As can be seen in FIG. 1, the fixed structure (16) is positioned in the chain (10) so that the inspection conveyor (28) lies parallel to the production conveyor (12). In addition, in this example, the structure (16) is anchored to the ground by pedestal feet (36).

In order to guide a bottle to be inspected from the production conveyor (12) to the inspection conveyor (28), the fixed structure (16) also includes first means (38) for transfer from the production conveyor (12) to the inspection conveyor (28). Thus, the first transfer means (38) include first means (40) for guiding the entry of a bottle, that are intended to form a first passage between the two conveyors (12, 28).

In addition, the inspection conveyor (28) is intended to direct a bottle to be inspected to the inspection module (18), and to redirect the bottle, after it has been inspected, onto the production conveyor (12).

Thus, in order to guide a bottle (B), which has been checked by the inspection module (18), from the inspection conveyor (28) to the production conveyor (12), the fixed structure (16) also includes second means (42) for transfer from the inspection conveyor (28) to the production conveyor (12).

The second transfer means (42) include second means (44) for guiding the exit of the bottle, intended to form a second passage between the two conveyors (12, 28). The second exit guidance means (44) include a belt (46) for example.

In order to check the bottles coming from the inspection conveyor (28), the inspection module (18) includes inspection means (48).

The inspection means (48) include at least one sensor of the type making contact or not making contact with a bottle.

In addition, the inspection means (48) are preferably divided between different inspection stations (at least two stations) that are intended to check different quality parameters of the bottles (at least two quality parameters).

Thus, in the example described, the inspection module (18) includes four inspection stations between which the inspection means (48) are divided, namely:
a first station (P1) to check the waterproofing of the bottles;
a second station (P2) to check for the presence of crazing on the bottles;
a third station (P3) to check the thickness of the bottle wall;
a fourth station (P4) to check the mould number formed in relief on the bottles.

The inspection means of the first station (P1) include, for example, pressure sensors (54) that are intended to check the sealing of the bottles and, where appropriate, mechanical sensors that are intended to check that the bottles are not blocked. In a variant, the means to check the station P1 can possibly include an image sensor in order to check for sealing of the bottles and that the bottles are not blocked.

The inspection means of the second station (P2) include, for example, optical sensors (50) or image sensors that are sensitive to a light beam that is transmitted or reflected by a bottle to be inspected, in order to check for the possible presence of crazing on the bottles. To this end, the means to check station P2 also include a light source (52) that is intended to illuminate the bottle (B) to be inspected. The optical sensors (50) can possibly include optical fibres to collect the light beam emitted by the light source (52).

In the conventional manner, the optical (50) and pressure (54) sensors respectively convert a light beam and a pressure into electrical signals.

The inspection means of the third station (P3) include, for example, a capacitive sensor (53) to check the thickness of the wall of the bottle. In order to check the thickness of the wall over the entire periphery of the bottle, the means to check station P3 also include means (not shown) that are intended to make the bottle rotate on itself.

The inspection means of the fourth station (P4) include, for example, an image sensor (51), for the inspection of a mould number formed in relief on the wall or the bottom of the bottle to be inspected.

Additional inspection means can also be divided between other inspection stations, for example, in order to check for ovalisation of the bottle, to check for the evenness of the bottle, etc.

The inspection module (18) also includes means (56) for examination of the electrical signals transmitted by the sensors (50, 51, 53 or 54), with these examination means (56) being connected electrically to the optical sensors (50), to the image sensor (51), to the capacitive sensor (53) and to the pressure sensors (54).

The inspection module (18) also includes means for adjusting the parameters (at least one parameter) of the inspection means (48) of each station (P1 to P4).

A parameter of the inspection means (48) can be a position of these inspection means (48) for example, in particular a relative position of a sensor (50, 51, 53 or 54) with the bottle (B), a position of the light source (52), a relative position of the optical sensor (50) and of the image sensor (51) with the light source (52).

When the parameter of the inspection means is a position as mentioned above, the means for the adjustment of this parameter include conventional means (58), which are adjustable in position, carrying, as appropriate, the optical sensors (50), the image sensors (51), the capacitive sensors (53), the pressure sensors (54) and the light source (52).

A parameter of the inspection means (48) can also be an electrical parameter, in particular the gain of an electrical signal transmitted, as appropriate, by one of the optical sensors (50), the image sensor (51), the capacitive sensor (53) and the pressure sensors (54) to the means (56) for examination of the electrical signal.

The inspection module (18) also includes means (60) for the guidance of a bottle (B) to the inspection means (48). In particular, the guidance means (60) are intended to move each bottle to be inspected from one inspection station to another inspection station.

The guidance means (60) preferably include a carrousel (62) with at least one cell (64) to accommodate a bottle (B) coming from the inspection conveyor (28). More particularly, the inspection stations (P1 to P4) are divided around various positions about the carrousel (62).

The carrousel (62) is intended to rotate each bottle between the inspection stations (P1 to P4).

In order to maintain the bottle (B) to be checked in the receptacle cell (64), the inspection module (18) possibly includes means (66) to hold the bottle in the cell (64) that include, for example, several elements (66A) in the general form of sectors of arcs connected together at an angle.

In order to rotate the carrousel (62), the inspection module (18) includes first means (68) for coupling the guidance means (60) to the motor drive means (70). These means (70) include mechanical stepping means (71) that, in a variant, can be replaced by electronic control means.

In addition, in order to engage a bottle coming from the inspection conveyor (28) in a receptacle cell (64), the fixed structure (16) includes means (72) for the insertion of a bottle (B) into the carrousel (62) of the module (18). The insertion means (72) preferably include an endless screw.

In order to synchronise the insertion of a bottle into a receptacle cell (64) in relation to a rotation speed of the carrousel (62), the fixed structure (16) includes second declutchable means (74) for coupling the drive motor (70) of the carrousel (62) to the insertion screw (72). In a variant, these means can be replaced by electronic control means.

In order to release a bottle from a receptacle cell (64), the inspection module (18) also includes means (76) for the removal of a bottle (B) from the carrousel (62) onto the inspection conveyor (28). The removal means (76) include means for guidance of the bottle, both fixed (78) and rotating (80).

In addition, in order to electrically power the elements of the inspection module (18) such as, for example, the drive motor (70) of the carrousel (62), the examination means (56) and the sensors (50, 51, 53, 54), the module (18) includes additional means (not shown) for connection to the electrical connection means (82) of the fixed structure (16).

Thus, the electrical connection means (82) of the structure (16) are, for example, connected electrically to the electrical power transformer housed in the receptacle (34).

The inspection installation (14) also includes means (not shown) for the ejection of a bottle (B) that has been identified as not to specification by the examination means (56).

In addition, the installation (14) also includes computer controlled means (not shown) connected to a display screen (84) to control the operation of the various elements of the installation (14), in particular of the drive motors, the conveyor and the ejection means, etc.

These computer controlled means are inserted into a receptacle (86) on the fixed structure (16), for example.

According to the invention, the inspection module (18) is intended to be attached to the fixed structure (16) by disconnectable connecting means (88). The inspection module (18) is also mobile. To this end, the inspection module (18) is equipped with rollers (90) with which it is moved, preferably over relatively short distances. For longer distances, it is preferable to move the module (18) by means of a carrier such as the one described below. Where appropriate, the module (18) may not include rollers (90).

Thus, in this example, the inspection module (18) is of general parallelpipedic form, and is intended to be inserted into a receptacle (92) of complementary shape created on the fixed structure (16). In a variant, the general form of the inspection module (18) could be different.

More precisely, the disconnectable connecting means (88) include at least one element for attaching the module (18) to the structure (16). The attachment element is preferably of the quick release type, such as a lash cleat for example, fixed onto the structure (16).

Other attachment elements may be equally suitable, such as a rotating flange, a threaded pin, or indeed a clamping bracket.

In order to position the module (18) precisely in relation to the structure (16), the inspection module (18) includes first positioning means (94) which determine a horizontal plane for vertical positioning of the module (18). These means (94) for positioning of the module are intended to be superimposed onto positioning means (96), which determine a plane on the fixed structure (16).

The inspection module (18) also includes second means (98) which determine a positioning axis of the module (18) around a vertical Z axis, and third means (not shown) which determine an angle of the module around the Z axis.

In this example, the second positioning means (98) are of the conical type, and the third positioning means are of the type with an oblong hole. In a variant, the second positioning means are of the complementary pin and hole type and/or the third means are of the horizontal edge type.

More precisely, the second (98) and third positioning means are intended to fit together by respective vertical interlocking with complementary means on the structure (16) (see FIG. 2).

Thus, FIG. 3 represents complementary means of the type with an oblong hole (100), intended to fit together with the third positioning means. However the complementary means of the conical type are not shown in FIG. 3.

In order to vertically interlock and release the module (18) in relation to the structure (16), the module (18) includes means (not shown) for attaching the module (18) to a carrier (102) of the lift type (see FIGS. 2 and 5).

This carrier (102) includes attaching means (104) fixed onto a vertical wall (106) of the carrier (102). The wall (106) includes a grasping handle (108). The vertical position on the Z axis of the attaching means (104) on the wall (106) can be adjusted using a crank (110) fixed onto the wall (106).

The carrier (102) includes a base (112) equipped with roller means (114). The base (112) includes, for example, parallel horizontal arms (116) fitted with wheels (118) intended to be located under the module (18), as can be seen in FIG. 2.

The arms (116) are connected at one of their ends to the vertical wall (106).

The carrier (102) is intended firstly to interlock or release the inspection module (18) in relation to the structure (16), and secondly to transport the inspection module (18) between the inspection installation (14) and an adjustment installation (120) represented in FIG. 6.

In particular, the adjustment installation (120) includes an adjustment structure (122) with a receptacle (124) that is intended to house an inspection module (18) according to the invention.

To this end, the adjustment installation (120) includes releasable connecting means (126) to the inspection module (18). The connecting means (126) are identical to those of the inspection installation (114) for example.

The adjustment installation (120) also includes means (128) for positioning the module (18) in relation to the structure (122).

These positioning means (128) are, for example, complementary positioning means on the first (94), second (98) and third positioning means of the inspection module (18).

Thus, this adjustment installation (120) is intended to form a stable support for adjusting the parameters of the inspection means (48).

The adjustment installation (120) also includes hardware and software computer means designed & for adjusting the parameters of the inspection means (48) (not shown).

To this end, the installation (120) also includes a receptacle (130) to accommodate the computer means. In this example these computer means are connected to a display screen (132).

In addition, in order to electrically power the elements of the inspection module (18) during adjustment of the parameters of the inspection means (48), the installation (120) also includes a receptacle (134) that is intended to house an electrical transformer and electrical connection means (136) that are complementary to the connection means of the module (18).

A description follows of certain aspects of the operation of the inspection (14) and adjustment (120) installations according to the invention.

Initially, we consider that the inspection installation (14) includes a first inspection module (18) in which the parameters of the inspection means (48) are set for the inspection of a first series of glass bottles, such as bottles with a volume of 0.5 litres, for example.

While the bottles of the first series are inspected, we adjust the parameters of the inspection means (48) of a second inspection module attached to the fixed structure of the adjustment installation (120) for the inspection of a second series of glass bottles, such as bottles with a volume of 1 litre, for example. In particular, we adjust the parameters of position inspection means (48), such as the relative position of the sensors of the different inspection stations (P1 to P4) in relation to the carrousel (62), and we also adjust the electrical parameters of the sensors (50, 51, 53 and 54).

Finally, to check the first bottle series, since the first and second modules are fixed respectively to the inspection (14) and adjustment (110) installations by means that can be undone, it is easy to exchange the two modules.

Thus, using the carrier (102) and rollers on the two modules, the first and second modules are moved between the two installations (14, 120).

The first module initially fixed to the inspection installation (14) is then moved and fixed to the adjustment installation (120) using the disconnectable connecting means.

The second module fixed to the adjustment installation (120) is moved and attached to the inspection installation (14) using the disconnectable connecting means.

In addition, the modules are positioned precisely in the corresponding installation structures using the positioning means. The electrical connections are also effected in order to connect the power elements of the modules.

By means of the invention, because adjustment of the parameters can be effected on the adjustment installation (120) outside of the production line (12), the down time of the chain in the event of changing the bottle series is very much reduced.

1. A module (18) for the inspection of an article, of the type with means for inspection (48) of the article, means (58) for adjusting at least one parameter of the inspection means (48) of the article, and means for guiding (60) article to the inspection means (48), characterised in that it is mobile and includes disconnectable connecting means (86) to a fixed structure (16).

2. An inspection module (18) according to claim 1, which includes first means for coupling (68) the guidance means (60) with a drive motor (70).

3. An inspection module (18) according to claim 1, in which the guidance means include a carrousel with at least one cell (64) to accommodate the article.

4. An inspection module (18) according to claim 3, which includes means (76) for releasing an article from the carrousel (62) toward an inspection conveyor (28) supported by the fixed structure (16).

5. An inspection module (18) according to claim 4, in which the removal means (76) include fixed (78) and rotating (80) means for guidance of the article).

6. An inspection module (18) according to claim 1, in which the inspection means (48) include at least one sensor of the type in contact or not in contact with the article.

7. An inspection module (18) according to claim 6, in which the sensor is chosen from among a optical sensor (50) that is sensitive to a light beam that is transmitted or reflected by the article, an image sensor (51), a capacitive sensor (53) and a pressure sensor (54).

8. An inspection module (18) according to claim 6, in which the parameter of the inspection means (48) is
a parameter for positioning these inspection means (48), such as a relative position of the sensor (50, 51, 53, 54) with the article, a position of a light source (52) of the inspection means (48), a relative position of the sensor (50, 51) with a light source (52) of the inspection means (48) or
an electrical parameter of these inspection means (48), such as the gain of an electrical signal transmitted by the sensor (50, 51, 53, 54) to means (56) for examination of the electrical signal.

9. An inspection module (18) according to claim 1, in which the inspection means (48) are divided between at least two inspection stations (P1, P2, P3, P4) intended respectively to check at least two quality parameters of the article, with the guidance means (60) being intended to move the article from one inspection station (P1, P2, P3, P4) to another inspection station (P1, P2, P3, P4).

10. An inspection module (18) according to claim 1, that have a general parallelpipedic form, and that are intended to be inserted into a receptacle (92) of complementary shape created on the fixed structure (16)

11. An inspection module (18) according to claim 1, in which the disconnectable connecting means (88) include at least one element for attaching the module to the structure chosen from among a rotating flange, a threaded pin, an element of the quick release type, and a clamping bracket.

12. An inspection module (18) according to claim 1, which includes:
first positioning means (94) which determine a horizontal plane for vertical positioning of the module,
second positioning means (98) which determine an axis for positioning of the module around a vertical Z axis,
third positioning means which determine a positioning angle of the module around the Z axis,
where the second (98) and third positioning means are intended to fit together by vertical interlocking with complementary means on the structure (16).

13. An inspection module (18) according to claim 12, in which the second positioning means (98) are of the conical type or of the complementary pin and hole type, and the third positioning means are of the horizontal edge type or the type with an oblong hole.

14. An inspection module (18) according to claim 12, which includes means for attaching the module (18) to a carrier (102) of the lift type, intended for vertical interlocking and separation of the module (18) in relation to the structure (16).

15. An inspection module (18) according to claim 1, which includes electrical connection means that are complementary to electrical connection means (82) on the structure (16).

16. An inspection module (18) according to claim 1, equipped with rollers (90) with which it is moved.

17. An inspection module (18) according to claim 1, intended for the inspection of a glass article, and in particular a bottle (B).

18. An installation (14) for inspection of an article, of the type with an inspection module (18) and a fixed structure (16), characterised in that the inspection module is in accordance with claim 1, and is fixed to the structure (16) by the disconnectable connecting means (88).

19. An installation (14) for inspection of an article according to claim 18, which includes an inspection module according to claim 2, and in which the structure (16) includes an inspection conveyor (28) and means (72) for insertion of an article coming from the inspection conveyor (28) in the carrousel (62) of the module (18).

20. An inspection installation (14) according to claim 19, in which the insertion means (72) include an endless screw.

21. An inspection installation (14) according to claim 19, which includes first transfer means (38) from a production conveyor (12) to the inspection conveyor (28), and second transfer means (42) from the inspection conveyor (28) to the production conveyor (12), the first (38) and second (42) transfer means respectively having first (40) and second (44) means for guidance of the article, intended to form first and second passages between the two conveyors (12, 28).

22. An inspection installation (14) according to claim 1, which includes an inspection module (18) according to claim 5 and in which the fixed structure (16) includes declutchable second means (74) for coupling the drive motor (70) to the insertion means (72).

23. An installation (120) for adjustment of an inspection module (18) that includes this inspection module (18) and a fixed structure (122), characterised in that the inspection module (18) is according to claim 1, and is fixed to the structure (122) by the disconnectable connecting means (126), and in that it includes computer hardware and software means designed for adjusting the parameter of the inspection means (48).
